(19) United States
(12) Patent Application Publication
(10) Pub. No.: US 2007/0140292 A1
(43) Pub. Date: Jun. 21, 2007

(54) De-interleaver synchronization methods and apparatus

(76) Inventors: Charles Kasimer Sestok IV, Dallas, TX (US); Seok-Jun Lee, Allen, TX (US); Manish Goel, Plano, TX (US)

Correspondence Address: TEXAS INSTRUMENTS INCORPORATED, P O BOX 655474, M/S 3999, DALLAS, TX, 75265, US

(21) Appl. No.: 11/311,447

(22) Filed: Dec. 17, 2005

(51) Int. Cl. H04J 3/22

(52) U.S. Cl. 370/465; 370/389

(57) ABSTRACT

A methods and apparatus for synchronizing a de-interleaver are disclosed. One example method includes fixing a phase of a de-interleaver in a first state; de-interleaving symbols in the signal while the phase of the de-interleaver is in the first state; processing the de-interleaved symbols; detecting if the known information is present in the processed de-interleaved symbols; and switching the phase of the de-interleaver between the first state and a second state when the known information is detected in the processed de-interleaved symbols.

### TECHNICAL FIELD

The present disclosure pertains to communication systems and, more particularly, to de-interleaver synchronization methods and apparatus.

### BACKGROUND

As broadcast technology and digital communication has progressed, the communication of audio, video, and data has moved from communications between a fixed transmitter (e.g., a television broadcaster) and a fixed receiver (e.g., a television in a viewer's home) to communications that are received and processed by mobile devices (e.g., cellular telephones, etc.). One standard for communications to mobile devices is the Digital Video Broadcasting-Handheld (DVB-H) standard, which is a technical specification for bringing broadcast services to handheld receivers. This standard was formally adopted as ETSI standard EN 302 304 in November 2004.

DVB-H is the latest development within the set of DVB transmission standards. DVB-H technology adapts the successful Digital Video Broadcasting-Terrestrial (DVB-T) system for digital terrestrial television to the specific requirements of handheld, battery-powered receivers. DVB-H offers a downstream channel at high data rates that can be used standalone or as an enhancement of mobile telecommunications networks, which many typical handheld terminals are able to access.

DVB-H uses a coded orthogonal frequency domain modulation (OFDM) scheme such that data are modulated and de-modulated in blocks by Fast Fourier Transform (FFT) and Inverse Fast Fourier Transform (IFFT) functions. DVB-H allows for 2048 (2K), 4K, and 8K point FFTs and IFFTs. A subset of the carriers in these blocks contains useful data. The remaining carriers are pilot carriers, transmission parameter signaling (TPS) carriers, or empty carriers. Nevertheless, the notation of the 2K, 4K, or 8K block or symbol is used throughout this document to refer to the entire set of useful data carriers.

To provide error correction functionality, concatenated convolutional and Reed-Solomon (RS) codes are used. Interleaving and de-interleaving of data is an important aspect of the encoding and decoding process.

Additionally, DVB-H uses time slicing technology to reduce power consumption for small handheld terminals. That is, information is transmitted as data bursts in small time slots. The front end of the receiver switches on only for the time slot when the data burst of a selected service is on air. Within this short period of time a high data rate is received and can be stored in a buffer. This buffer can either store the downloaded applications or play out live streams. The achievable power saving depends on the relation of the on/off-time. In DVB-H synchronization between the data transmitter and the data receiver must be achieved before received data is meaningful. To conserve power in the mobile unit, rapid synchronization before each time slot is important. That is, ideally the receiver should be powered for a minimal amount of time to synchronize before receiving information in the time slot. As will be appreciated by those having ordinary skill in the art, at high data rates synchronization time makes a large contribution to the duty cycle of the receiver.

An added feature of the DVB-H standard is that DVB-H accommodates a deep symbol interleaver. The standard symbol interleaver used in DVB-H interleaves the data in each OFDM symbol independently. The deep symbol interleaver uses the interleaver pattern used in the 8K OFDM mode to interleave multiple symbols if the system is using the 2K or 4K symbol size. Thus, the deep symbol interleaver interleaves data from two consecutive OFDM symbols if the 4K OFDM mode is being used and interleaves data from four consecutive OFDM symbols if the 2K OFDM mode is being used.

In standard operation, the DVB-H symbol interleaver alternates between two different patterns in consecutive realizations. These patterns are denoted as the even interleaver phase and the odd interleaver phase. In order to receive the DVB-H signal properly, the receiver must alternate between the de-interleaver patterns corresponding to the correct phases in lockstep with the alternating interleaver phases at the transmitter.

When the standard interleaver is in use, the receiver can determine the correct de-interleaver phase to use from the scattered pilot pattern. Since the pilot pattern has a period of four OFDM symbols, specification of the correct pilot phase in the current symbol also specifies the correct de-interleaver phase to use. This approach fails to synchronize the de-interleaver, however, when the 2K OFDM mode is combined with the deep symbol interleaver. Since the deep symbol interleaver interleaves four consecutive 2K symbols, the knowledge of the correct pilot phase does not enable the receiver to determine the correct deep symbol de-interleaver pattern.

One proposed solution is to perform synchronization in 2K mode with a transmission parameter signaling (TPS), but this is not desirable. As noted above, a symbol de-interleaver must be synchronized before every time slot. Using TPS information for synchronization requires up to 68 symbols for synchronization. Thus, to ensure synchronization by the start of the time slot, the receiver must be awake at least 68 symbols before the time slot to accommodate worst-case synchronization delay. As will be readily appreciated by those having ordinary skill in the art, this synchronization time reduces the power efficiency of the receiver.

### BRIEF DESCRIPTION OF THE DRAWINGS

FIG. 1 is a diagram of an example Digital Video Broadcast-Handset (DVB-H) system.

FIG. 2 is block diagram of an example transmission lineup of the DVB-H transmitter of FIG. 1.

FIG. 3 is a block diagram representing an example MPEG packet of a bitstream that may be provided to the multiplexer of FIG. 2.

FIG. 4 is a block diagram representing an example bitstream produced by the multiplexer and provided to the outer coder of FIG. 2.

FIG. 5 is a block diagram representing an example bitstream produced by the outer coder and provided to the outer interleaver of FIG. 2.

FIG. 6 is a block diagram representing an example bitstream produced by the outer interleaver and provided to the inner coder of FIG. 2.

FIG. 7 is a block diagram representing the conversion of 2K symbols to 8K symbols through the use of even and odd symbol patterns.

FIG. 8 is block diagram of an example receive lineup of the DVB-H mobile unit of FIG. 1.

FIG. 9 is a block diagram of an example implementation of the synchronization detector of FIG. 8.

FIG. 10 is a block diagram of an example implementation of the inner symbol de-interleaver of FIG. 8.

FIG. 11 is flow diagram representative of a synchronization process that may be carried out by the receive lineup of FIG. 8.

FIG. 12 is a block diagram of an example implementation of a portion of the receive lineup of FIG. 8.

FIG. 13 is a flow diagram representative of a synchronization process that may be carried out by the portion of the receive lineup of FIG. 12.

FIG. 14 is a block diagram of a second example implementation of a portion of the receive lineup of FIG. 8.

FIG. 15 is a flow diagram representative of a synchronization process that may be carried out by the portion of the receive lineup of FIG. 14.

FIG. 16 is a block diagram of a processor system on which some portions of the receive lineups of FIGS. 8, 12, and 14 may be implemented.

### DETAILED DESCRIPTION

Although the following discloses example systems including, among other components, hardware and software executed on hardware, it should be noted that such systems are merely illustrative and should not be considered as limiting. For example, it is contemplated that any or all of these hardware and software components could be embodied exclusively in dedicated hardware, exclusively in software, exclusively in firmware or in some combination of hardware, firmware and/or software. Accordingly, while the following describes example systems, persons of ordinary skill in the art will readily appreciate that the examples are not the only way to implement such systems.

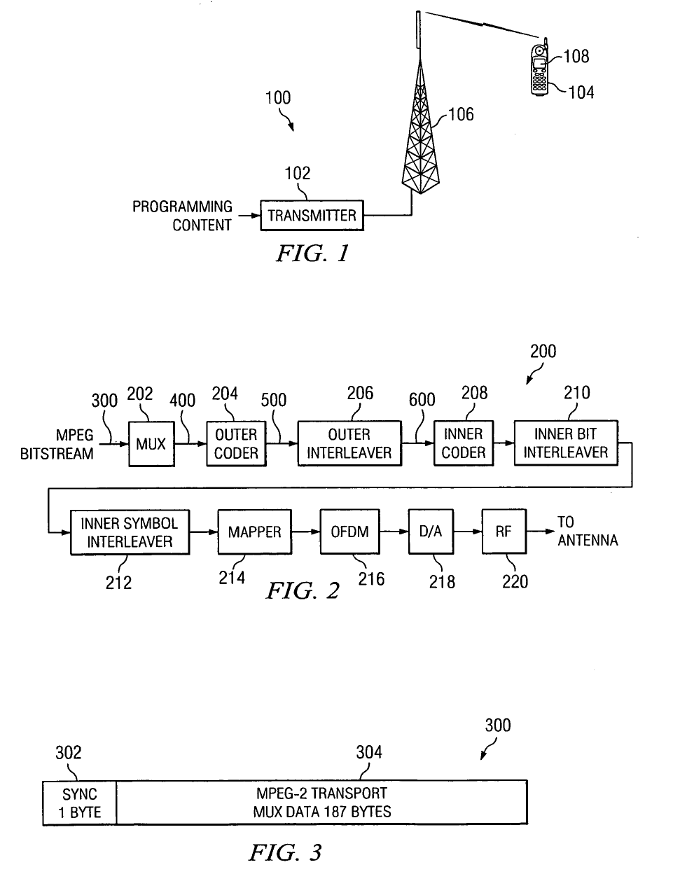

As shown in FIG. 1, a DVB-H system 100 includes a transmitter 102 and a mobile unit 104. As will be readily appreciated, the system 100 may include various other components and/or systems that, for the sake of clarity, are not shown in FIG. 1.

As described below in detail, the transmitter 102 receives programming content from various sources and processes and broadcasts the same via an antenna 106 to the mobile unit 104. Programming content may take various forms such as, for example, audio information, video information, data, and/or any combination of audio, video, or data. The programming content may be provided to the transmitter 102 in digital and compressed format. For example, the programming content may be video that is compressed into a Moving Pictures Experts Group (MPEG) format, such as MPEG-1, MPEG-2, or the like. Alternatively, the programming content may be provided to the transmitter 102 in an analog format and the transmitter 102 may digitize the same. The transmitter 102 is compliant with the DVB-H specification entitled “Annex 2 ETS 300 744 with 4k.doc,” which is available from a number of sources and is incorporated herein by reference, and processes information according to the DVB-H standard. The transmitter 102 outputs DVB-H signals for transmission to the antenna 106, which distributes the same over a geographical area. Of course, while one antenna 106 is shown in FIG. 1, it will be readily appreciated by skilled artisans that more than a single antenna may be provided and, in fact, the transmitter 102 may distribute the DVB-H signal to a network of antennas or other signal distribution components.

The mobile unit 104 receives the transmitted DVB-H signals and processes the same to produce, for example, video and audio that may be observed and heard by a user of the mobile unit 104. For example, the mobile unit 104 may include a display screen 108 on which video included in the programming content may be displayed. As described in detail below, the mobile unit 104 may efficiently synchronize the de-interleaver of the mobile unit to handle 2K interleaved information. Thus, as described below, the mobile unit 104 may realize relatively lower power consumption relative to TPS de-interleaver synchronization.

As shown in FIG. 2, a transmit lineup 200, which may be implemented within the transmitter 102, receives a bitstream (e.g., an MPEG video bitstream) and processes the bitstream in accordance with the DVB-H specification to produce radio frequency (RF) signals for transmission. Generally, the transmit lineup 200 includes a multiplexer 202, an outer coder 204, an outer interleaver 206, an inner coder 208, an inner bit interleaver 210, and an inner symbol interleaver 212. Additionally, the transmit lineup 200 may include a mapper 214, an OFDM modulator 216, a digital-to-analog (D/A) converter 218, and an RF block 220. Further details regarding these aspects are provided below, the description of some of which is provided in conjunction with the block diagrams in FIGS. 3-6.

The multiplexer 202 receives a bitstream, which may include a number of MPEG-2 packets, such as the one shown at reference numeral 300 of FIG. 3. The multiplexer 202 performs energy dispersal to randomize data collected from several MPEG packets.

Referring briefly to FIG. 3, an MPEG-2 packet 300 includes a synchronization byte header 302, which is followed by a 187 byte payload of MPEG-encoded information 304. The synchronization byte 302 may be a well known synchronization byte such as, for example, 0×47 or 0×B8 (which is used as a header on a frame of packets). Alternatively, the synchronization byte 302 may be any agreed upon designator that indicates the start of an MPEG payload. Further, other data lengths than that of a byte may be used for synchronization.

The result of the operation of the multiplexer 202 is a bitstream such as that shown in FIG. 4. As shown in FIG. 4, a synchronization header ( S̅Y̅N̅C̅H̅1̅) 402, which may be 0×B8 as discussed above, precedes a payload of 187 bytes of randomized data 404. As shown in FIG. 4, eight sequences of synchronization headers and payloads may be grouped together, wherein each payload other than the first payload preceded by 0×47 and the first payload of the eight consecutive payloads is preceded by a 0×B8 frame synchronization header.

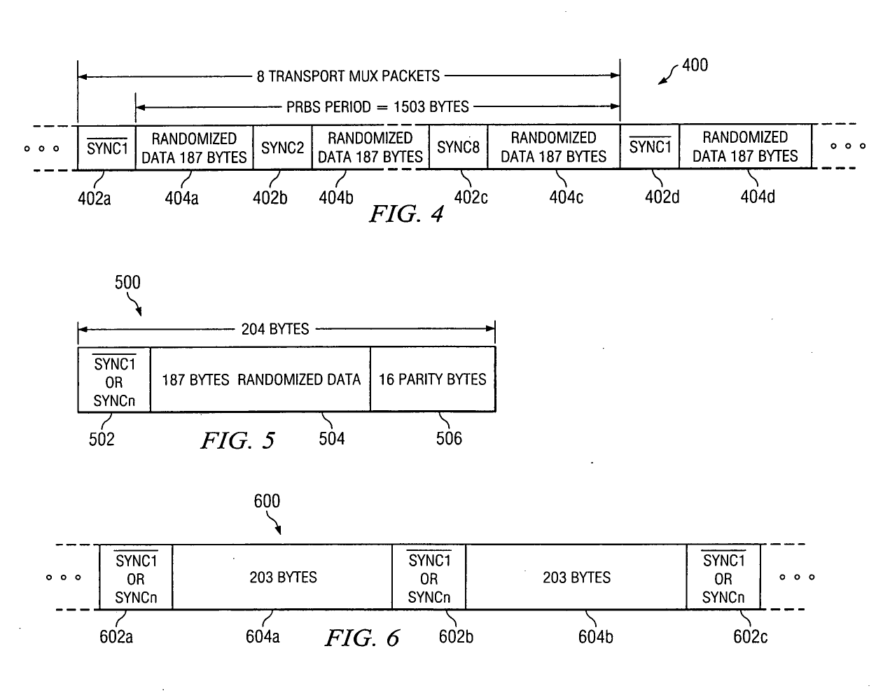

The bitstream from the multiplexer 202, such as the bitstream shown in FIG. 4, is provided to the outer coder 204. The outer coder 204 may be implemented using a Reed-Solomon encoder, or any other suitable encoder. In one particular example, the outer code may be a Reed-Solomon (204, 188, t=8) shortened code. Such outer coding processes 188 bytes and produces 16 parity bytes that are appended to the 188 bytes (i.e., the synchronization header 402 and the payload 404). For example, as shown in FIG. 5 at reference numeral 500, a synchronization header 502 (e.g., 0×47 or 0×B8) precedes the payload of 187 randomized bytes 504, which are followed by 16 Reed-Solomon parity bytes 506. Note that at this point, the synchronization header has not been affected by the operations performed by the multiplexer 202 or the outer coder 204. That is, each 187 byte payload 504 is still preceded by a single synchronization byte 502.

The output of the outer coder 204 is provided to the outer interleaver 206. The outer interleaver 206 may be, for example, a convolutional interleaver having 12 branches, with each branch having a different delay and the first branch having no delay. When the outer interleaver 206 operates, the synchronization headers 502 always follow the no delay path. Thus, as shown at reference numeral 600 of FIG. 6, the output of outer interleaver 206 is a bit stream having a synchronization header 602 followed by 203 bytes of information 604, which are made up a combination of 187 bytes of randomized data and the 16 parity bytes provided by the Reed-Solomon encoding performed by outer coder 204. Again, note that the synchronization headers (e.g., 0×47 and 0×B8) remain intact and have a 204 byte periodicity.

The output of the outer interleaver 206 is coded by an inner coder 208, which may be implemented as a known convolutional encoder and the bits may be interleaved by the inner bit interleaver 210. As will be readily appreciated by those having ordinary skill in the art, the inner bit interleaver 210 may shuffle, for example, 126 bits in a known and predictable manner.

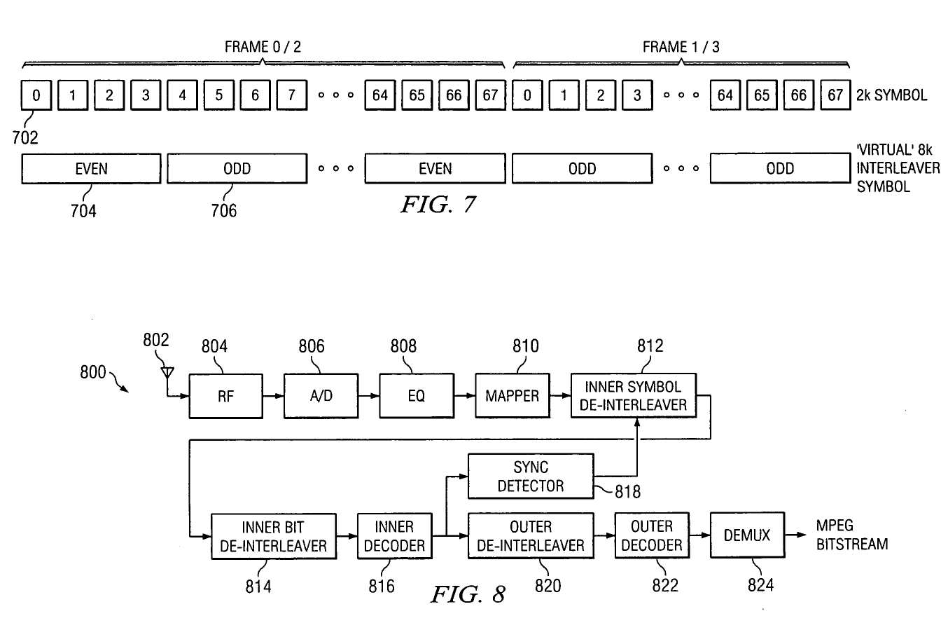

Subsequently, the shuffled bits are coupled to an inner symbol interleaver 212 that may shuffle symbols in 8K, 4K, or 2K segments. As is known by those having ordinary skill in the art, 2K OFDM symbols are combined with virtual 8K interleaver symbols, which may be odd and even phases of a four symbol pilot signal, to produce an 8K symbol stream, which will completely fill an 8K symbol buffer in an inner bit de-interleaver. For example, referring to FIG. 7, 2K symbols, one of which is referred to with reference numeral 702, are each combined with either an even symbol pattern 704 or an odd symbol pattern 706. As noted above, the even symbol pattern 704 or the odd symbol pattern 706 each include four symbols. Accordingly, by combining each 2K symbol with four symbols (selectively even or odd, as shown in FIG. 7), the resulting signal is an 8K symbol stream. As will be readily appreciated by those having ordinary skill in the art, the combination of the even symbol pattern 704 and the odd symbol pattern 706 with the 2K symbols may be carried out using a feedback shift register sequence or any other suitable function.

Because the 2K symbols are combined with alternating even and odd symbol patterns to generate an 8K symbol stream (as shown in FIG. 7), the 2K symbols can only be recovered at a receiver if the 8K symbol stream is combined with synchronized, alternating even and odd symbol patterns. That is, the 2K symbols can only be seen at the receiver when, for example, the 8K symbol stream is XORed at the proper locations (i.e., synchronized) with the even or odd symbol patterns. As described below, when the symbols are interleaved in 2K segments conventional synchronization in a receiver may be time consuming due to the alternating odd and even nature of the symbol patterns combined with the 2K symbol signal, but the disclosed synchronization process is quite rapid.

The shuffled symbols from the inner symbol interleaver 212 are then mapped to a Quadrature Amplitude Modulation (QAM) constellation by the mapper 214. As will be readily appreciated by those having ordinary skill in the art, groups of bits may be mapped to a single constellation point. For example, two bits may be mapped to a single point in a Quadrature Phase Shift Keying (QPSK) constellation, four bits may be mapped to a single 16-QAM constellation point, or six bits may be mapped to a single 64-QAM constellation point.

Data representing the constellation points (e.g., in-phase and quadrature magnitudes) are processed by the OFDM 216 to produce carriers representing the constellation points. The carriers are generated in the frequency domain and processed by an IFFT to produce a time domain signal that is converted to an analog format by the D/A 218 and appropriately upconverted by the RF block 220. The output of the RF block 220 may be further amplified as appropriate for broadcast by the antenna 106.

Importantly, no matter what coding or interleaving is used in the transmit lineup 200, the synchronization bytes (e.g., 0×47 or 0×B8) preceding every 203 bytes of information 604 are visible. As described below, it is this information that will be used to quickly synchronize a receive lineup.

An example receive lineup, such as may be found in the mobile unit 104 of FIG. 1, is shown at reference numeral 800 in FIG. 8. As shown in FIG. 8, the example receive lineup 800 includes an antenna 802, a receive RF block 804, an analog-to-digital (A/D) converter 806, an equalizer 808, and a mapper 810. Further, the example receive lineup 800 includes an inner symbol de-interleaver 812, an inner bit de-interleaver 814, and an inner decoder 816. An output from the inner decoder 816 feeds a synchronization detector 818, which, as described in detail below, controls operation of the inner symbol de-interleaver 812. Additionally, the inner decoder 816 is coupled to an outer de-interleaver 820 that is coupled to an outer decoder 822, which feeds a demultiplexer 824.

As described above, the transmit lineup 200 receives a bitstream, such as an MPEG bitstream, and converts that bitstream into signals for transmission. In operation, the receive lineup 800 receives the transmitted signals and processes such signals to recover the bitstream originally provided to the transmit lineup 200. In this manner, the bitstream may be distributed to multiple mobile units as a broadcast signal and those mobile units may process the broadcast signal to receive the bitstream. In addition, the receive lineup 800 uses information in the stream to quickly synchronize the inner symbol de-interleaver 812 even when 2K symbol interleaving is used by the transmit lineup 200.

The antenna 802 receives the broadcast signal including the OFDM components that were used to transmit coded and interleaved information. The signals received by the antenna 802 are processed by the receive RF block 804, which may downconvert or otherwise process the received signals to baseband signals before they are converted to the digital signals by the A/D 806 and equalized by the equalizer 808.

The equalized signals, which represent in-phase and quadrature magnitudes, are mapped to constellation points. For example, if QPSK is used, the in-phase and quadrature components are mapped to a constellation QPSK point representing two symbols. By way of an alternative example, if 64-QAM is used for modulation, the in-phase and quadrature components are mapped to a constellation point representing six symbols. That is, the mapper 810 performs the inverse of the mapping performed by the mapper 214 of FIG. 2.

The output of the mapper 810 is provided to the inner symbol de-interleaver 812. As described in further detail below in conjunction with an example implementation of the inner symbol de-interleaver, the inner symbol de-interleaver 812 buffers 8K symbols and attempts to de-interleave the symbols, but must first be synchronized. If, for example, 8K or 4K interleaving was used in the transmit lineup 200, the inner symbol de-interleaver 812 easily synchronizes and de-interleaves the symbols. However, if 2K interleaving was performed with odd and even symbol patterns, the synchronization detector 818 works with the inner symbol de-interleaver 812 to achieve synchronization. As described in detail below, the synchronization detector 818 searches for the synchronization headers at the output of the inner decoder 816. Synchronization headers are spaced every 204 bytes. Therefore, when a number of consecutive synchronization headers are received with the proper spacing the synchronization detector 818 informs the inner symbol de-interleaver 812 that it is properly phased. The situation in which a number of consecutive and properly spaced synchronization headers are detected is commonly referred to as Reed-Solomon lock (RS lock).

If the interleaving is 4K or 8K interleaving, the remainder of the system functions as is known by those having ordinary skill in the art. Thus, the remaining description will focus on the case in which 2K interleaving with odd and even symbol patterns are used for interleaving. In this case, the inner symbol de-interleaver 812 is either properly phased with respect to the buffered symbols or is improperly phased. If phasing is proper, the inner bit de-interleaver 814 and the inner decoder 816 cooperate to result in an output signal from the inner decoder 816 including a number of consecutive synchronization headers (e.g., 0×47 or 0×B8) (i.e., RS lock has been achieved). That is, the output of the inner decoder 816 is an MPEG transport stream that looks similar to the bitstream 600 of FIG. 6, which includes intact synchronization headers 602.

Conversely, if the phasing of the inner symbol de-interleaver 812 is not synchronized, an appropriate number of consecutive synchronization headers will not be received by the synchronization detector 818 (i.e., RS lock has not been achieved). Thus, the synchronization detector 818 will inform the inner symbol de-interleaver 812 to correct synchronization. As described in detail below, the signal from the synchronization detector 818 may inhibit phase changes in the inner symbol de-interleaver 812 until RS lock is achieved. In most cases, worst case synchronization time will be 8 OFDM symbols, which is a significant decrease over the time is takes to synchronize using TPS bits. When RS lock has been achieved, the inner symbol de-interleaver 812 resumes the odd and even symbol pattern alternations to remain synchronized. When synchronization is achieved, the inner symbol de-interleaver 812 may re-process symbols that were processed with the incorrect synchronization, thereby recovering information that was missed during asynchronous periods. Alternatively, the inner symbol de-interleaver 812 may process received symbols with two patterns that are out of phase with one another, which will result in one of the processed bitstreams being synchronized. The inner symbol de-interleaver 812 may then select the proper bitstream for output.

As will be readily appreciated, once synchronization is achieved, the outer de-interleaver 820, the outer decoder 822, and the demultiplexer 824 function to reconstruct the MPEG bitstream that was encoded, interleaved, modulated, and transmitted.

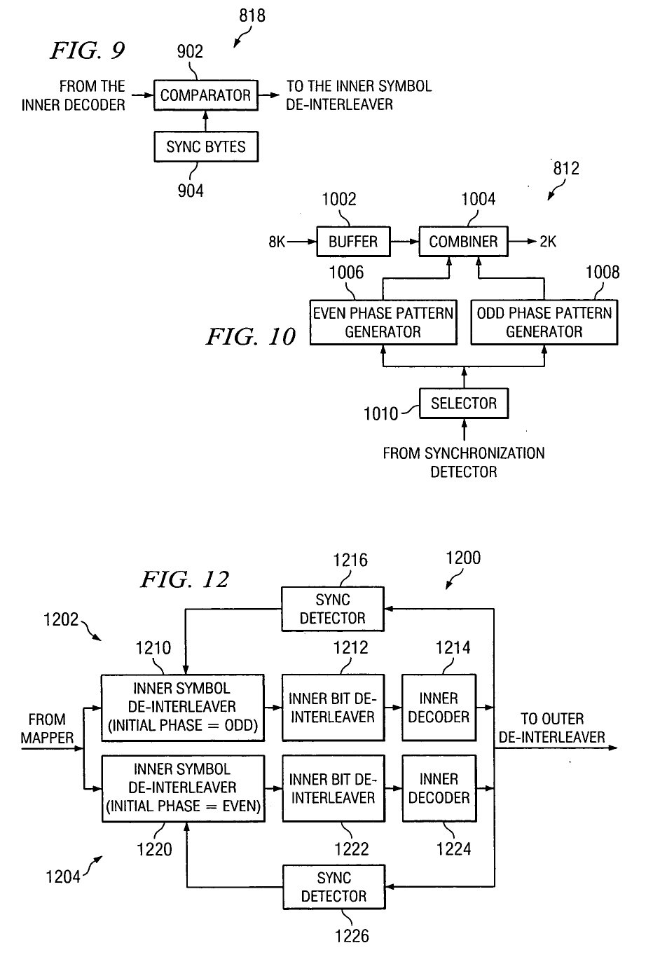

As shown in FIG. 9, one example implementation of the synchronization detector 818 may include a comparator 902 and synchronization byte storage 904. The comparator 902 is configured to receive decoded bytes from the inner decoder and compare each decoded byte to the synchronization bytes that are present in the headers of MPEG packets. This is possible because the encoding and interleaving performed by the transmit lineup 200 and the receive lineup do not alter the synchronization bytes. Thus, if the inner de-interleaver is properly synchronized (e.g., the odd and even symbol patterns are correctly being used by the inner de-interleaver), the synchronization bytes will appear in the output from the inner decoder with 204 byte spacing.

The comparator 902 may rely on a list of synchronization bytes stored in the synchronization byte storage 904 as a basis for comparison. For example, the synchronization byte storage 904 may store 0×47 and 0×B8. Alternatively, any other information that may be used as an indicator of inner de-interleaver synchronization may be stored in the synchronization byte storage 904.

In operation, when the comparator 902 detects a number of consecutive matches (i.e., matches spaced 204 bytes apart) between the symbols from the inner decoder and the synchronization bytes stored in the synchronization byte storage 904 (i.e., RS lock), the comparator 902 outputs an enable signal to the inner symbol de-interleaver 812 to enable the inner symbol de-interleaver to alternate between odd and even symbols patterns to maintain synchronization.

In the alternative, when no match exists (i.e., when RS lock is not achieved), the comparator 902 does not output the enable signal and the inner symbol de-interleaver 812 is prevented from switching between odd and even symbol patterns and, therefore, only outputs a single symbol pattern (i.e., either the odd symbol pattern or the even symbol pattern). This mode of attempting to find synchronization will continue until synchronization is achieved or TPS information has been processed to determine the correct interleaver mode. Further detail regarding the operation of the inner symbol de-interleaver 818 is provided below.

As shown in FIG. 10 one example implementation of the inner symbol de-interleaver 812 of FIG. 8 includes a buffer 1002, a combiner 1004, an even phase pattern generator 1006, an odd phase pattern generator 1008, and a selector 1010. In operation, the buffer 1002 stores a frame of 8K symbols that are received from the mapper 810 of FIG. 8. The combiner 1004 combines the buffered symbols with even or odd symbol patterns from the even and odd phase pattern generators 1006, 1008 so that the combiner outputs the 2K symbol stream. The selector 1010, when enabled by the synchronization detector 818, dictates which of the even phase pattern generator 1006 and the odd phase pattern generator 1008 is enabled and, thus, dictates the synchronization between the even symbol pattern and the odd symbol pattern with the buffered 8K symbols.

In particular, when enabled (i.e., when RS lock is achieved), the selector 1010 alternates between enabling the even phase pattern generator 1006 and the odd phase pattern generator 1008 every four symbols to maintain synchronization. However, when synchronization is not achieved (i.e., no RS lock), the selector 1010 is not enabled and, therefore, does not alternatively enable the pattern generators 1006, 1008. Rather, in such an instance, the selector 1010 only enables one of the pattern generators 1006, 1008, and continues to enable that symbol pattern generator until synchronization is achieved, as detected by the synchronization detector 818. Because, as described above, the synchronization header information is not disturbed by the encoding and interleaving process, fixing the symbol pattern combined with the buffered 8K signal will eventually result in synchronization when received data has been combined with the selected symbol pattern (i.e., odd or even) selected by the receiver to achieve synchronization.

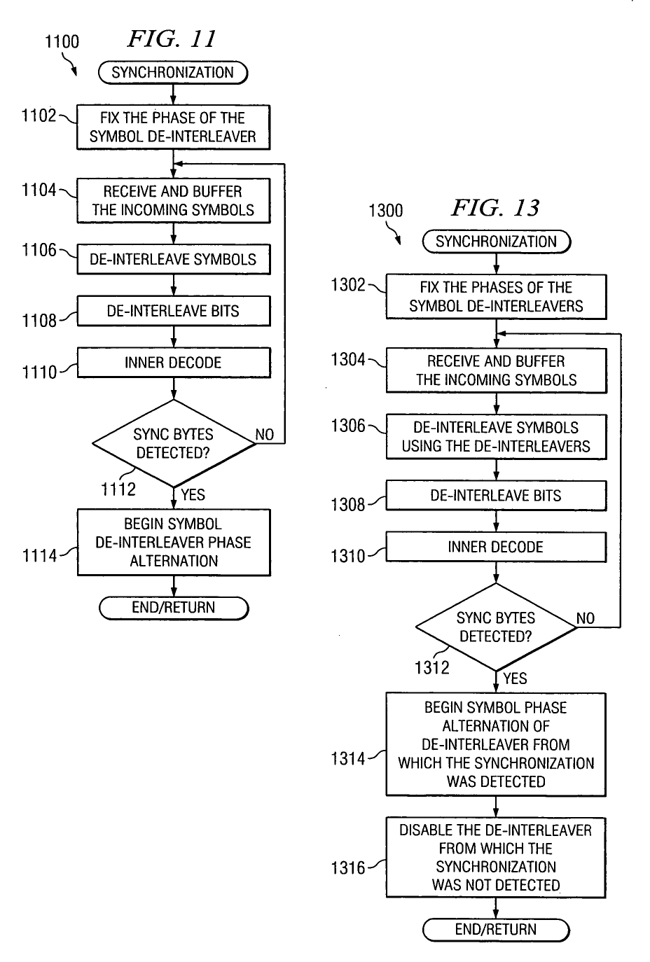

A flow diagram of an example synchronization process 1100 is shown in FIG. 11. The process 1100 may be implemented using any number of suitable techniques. For example, the process 1100 may be implemented using hardware blocks and/or by software and/or firmware executed by a processor. In one example, the process 1100 may be implemented using instructions stored on computer readable media (e.g., random access memory (RAM), read only memory (ROM), flash memory, hard disk, or any other suitable media) and executed by a digital signal processor (DSP). Of course, as will be readily appreciated by those having ordinary skill in the art, other implementations of the process 1100 may include combinations of hardware and/or software and/of firmware. Additionally, some portions of the process may be implemented manually.

The process 1100 may be initiated by, for example, a mobile unit, such as the mobile unit 104 of FIG. 1 prior to the communication time slot allocated to that mobile unit. The process 1100 facilitates rapid synchronization of 2K interleaved bitstreams when the transmitter selects the deep symbol interleaver and, therefore, reduces the period of time that the mobile unit must be awake prior to its communication time slot. Of course, the synchronization process could be utilized when receiving other interleaved signals than those having 2K interleaving.

When initiated, the process 1100, fixes the phase of the symbol de-interleaver (block 1102). For example, the process 1100 may set the symbol de-interleaver to use only the odd symbol pattern or only the even signal pattern. Fixing the symbol pattern to either odd or even enables a determination as to when synchronization occurs because when the symbol pattern is synchronized, MPEG synchronization bytes will be visible, as described below.

After the phase of the symbol de-interleaver is fixed (block 1102), the process 1100 receives and buffers incoming symbols (block 1104). The buffered symbols are then de-interleaved using the fixed phase of the symbol de-interleaver (block 1106). Of course, the synchronization may not be correct for the chosen symbol de-interleaver phase and the information resulting from the symbol de-interleaving may be unintelligible or meaningless. On the other hand, if synchronization is proper using the fixed symbol de-interleaver phase, the result of the de-interleaving will be subsequently meaningful, as described below.

To determine if synchronization is proper, the process 1100 performs bit de-interleaving on the de-interleaved symbols (block 1108) and performs inner decoding on the results (block 1110). At this point, the process 1100 determines if RS lock has occurred. In one example, RS lock may be determined by receipt of a sufficient number of consecutive synchronization bytes, such as synchronization bytes from MPEG headers (i.e., 0×47 and 0×B8), in the decoded and de-interleaved information (block 1112).

When synchronization bytes (or a sufficient number of them) are detected (i.e., RS lock has occurred) (block 1112), the phase of the symbol de-interleaver is proper for the frame being processed and, therefore, the phase of the symbol de-interleaver will need to change (e.g., from odd to even or from even to odd) to the properly synchronized with the next frame of symbols. Thus, when synchronization bytes are detected (block 1112), the process begins symbol de-interleaver phase alternation (block 1114), which will keep the de-interleaver in synchronization with the received symbols.

If synchronization bytes are not found or the number of consecutive synchronization bytes is not sufficient (i.e., RS lock has not been achieved) (block 1112), the process 1100 may determine if the number of bytes processed without synchronization has exceeded a byte count. If the byte count has not been exceeded the de-interleaver synchronization is improper, but will be proper at a future time when the transmitted signal is interleaved with a different phase symbol pattern, which occurs every four symbols at the transmitter. Thus, the process 1100 continues to receive and buffer incoming symbols (block 1104) and to process those symbols according to blocks 1106, 1108, and 1110, until synchronization bytes are detected (block 1112).

Once synchronization (i.e., RS lock) is achieved, the process 1100 may end or pass control back to a calling routine because the inner symbol de-interleaver is synchronized and, therefore, meaningful data may be received and processed.

FIG. 12 shows an alternate example of a portion of a receive lineup 1200 that may be located between the mapper 810 and the outer de-interleaver 820 of FIG. 8. In general, the receive lineup 1200 includes two synchronization branches: an odd phase branch 1202 and an even phase branch 1204. Each of the synchronization branches 1202 and 1204 processes symbols from the mapper, but each begins operation with a different initial phase.

The odd phase branch 1202 includes an inner symbol de-interleaver 1210 having an initial phase fixed to be odd. The inner symbol de-interleaver 1210 is coupled to an inner bit de-interleaver 1212, which is further coupled to an inner decoder 1214. An output from the inner decoder 1214 is coupled to a synchronization detector 1216.

The even phase branch 1204 is substantially similar to the odd phase branch 1202, but includes an inner symbol de-interleaver 1220 having an initial phase fixed to be even. The inner symbol de-interleaver 1220 is coupled to an inner bit de-interleaver 1222, which is further coupled to an inner decoder 1224. An output from the inner decoder 1224 is coupled to a synchronization detector 1226.

In operation, symbols from the mapper are coupled to both of the de-interleavers 1210 and 1220. As noted above, the de-interleavers 1210 and 1220 have opposite, fixed initial phases. Thus, the phase of one of the de-interleavers 1210 or 1220 will be proper. When the phase is proper, information from the inner decoder (e.g., either the inner decoder 1214 or the inner decoder 1224) will include synchronization information (e.g., a synchronization byte). The synchronization information, or consecutive occurrences thereof, is detected by a synchronization detector associated with the either the odd phase branch 1202 or the even phase branch 1204. The synchronization detector that detects the synchronization information (i.e., RS lock) informs the inner symbol de-interleaver associated with the detected synchronization information to begin phase alternation to maintain synchronization. The synchronization detector that does not detect synchronization information and, therefore, does not achieve RS lock, because its branch is not properly synchronized will eventually disable its associated inner symbol de-interleaver. The determination to disable the unsynchronized inner symbol de-interleaver may be based on an elapsed time since synchronization was detected, or may be based on communication from the synchronization detector that detected synchronization.

FIG. 13 is a flow diagram of a second example synchronization process 1300. Like the process 1100 described above, the process 1300 may be implemented using dedicated hardware and/or software or firmware executed on hardware, such as a DSP. The process 1300 is similar to the process 1100 of FIG. 11, but the process 1300 fixes the phases of both of the de-interleavers, one to be odd and one to be even (block 1302). After the buffering (block 1304), de-interleaving (blocks 1306 and 1308), and decoding (block 1310), the process 1300 determines if synchronization bytes have been detected (i.e., if RS lock has been achieved) (block 1312). If synchronization bytes have not been detected (i.e., RS lock has not been achieved), the process 1300 iterates the buffering (block 1304) and subsequent processing (blocks 1306, 1308, 1310).

When synchronization bytes are detected (block 1312), the process 1300 begins symbol phase alternation of the de-interleaver from which the synchronization was detected (block 1314). Subsequently, the de-interleaver from which synchronization was not detected is disabled (block 1316).

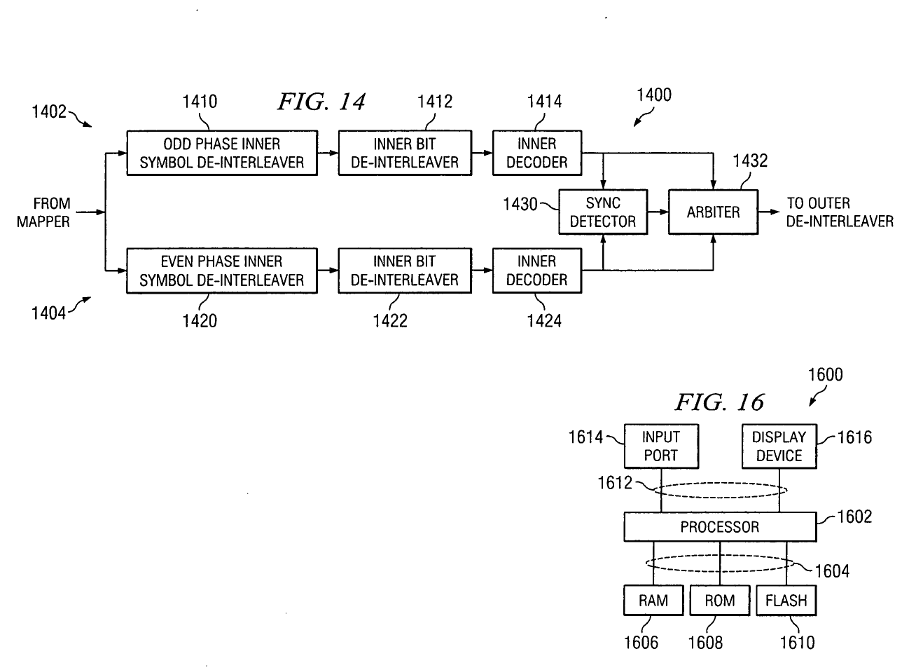

FIG. 14 shows a second alternate example of a portion of a receive lineup 1400 that may be located between the mapper 810 and the outer de-interleaver 820 of FIG. 8. In general, the receive lineup 1400 includes two synchronization branches: an odd phase branch 1402 and an even phase branch 1404. Each of the synchronization branches 1402 and 1404 processes symbols from the mapper, but has a different phase. The odd phase branch 1402 includes an odd phase inner symbol de-interleaver 1410, an inner bit de-interleaver 1412, and an inner decoder 1414. The even phase branch 1404 includes an even phase inner symbol de-interleaver 1420, an inner bit de-interleaver 1422, and an inner decoder 1424.

A synchronization detector 1430 receives output from each of the inner decoders 1414 and 1424 and determines which of the branches 1402 or 1404 is synchronized by examining the decoder outputs for synchronization bytes. When a number of properly spaced synchronization bytes are received (i.e., when RS lock is achieved), the synchronization detector 1430 informs an arbiter 1432 of the branch (i.e., the branch 1402 or the branch 1404) from which the synchronization bytes came. The arbiter 1432 then selects for output the corresponding output from the inner decoder 1414 or 1424. Subsequently, the arbiter 1432 alternates selection of the odd and even branches to maintain synchronization and the synchronization detector 1430 is no longer needed for that time slot.

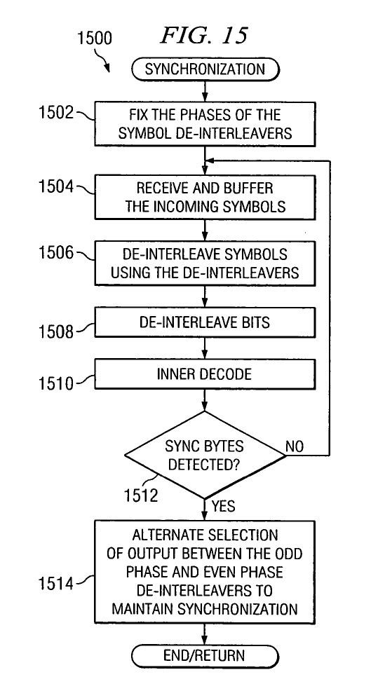

FIG. 15 is a flow diagram of a third example synchronization process 1500, such as may be carried out by a receive lineup such as the receive lineup 1400. Like the processes 1100 and 1300 described above, the process 1500 may be implemented using dedicated hardware and/or software or firmware executed on hardware, such as a DSP. The process 1500 is similar to the processes 1100 and 1300, but the process 1500 fixes the phases of both of the de-interleavers 1410 and 1420 and leaves those phases fixed and selects for output the bitstream from the phase that is in synchronization. As synchronization changes between the odd and even phases, the output of the synchronized phase is selected for output.

As shown in FIG. 15, the process 1500 fixes the phase of the de-interleavers and performs various buffering, decoding, and de-interleaving functions (blocks 1501, 1504, 1506, 1508, 1510). The process determines if synchronization bytes are selected (i.e., if RS lock has been achieved) (block 1512) and, when the proper number of synchronization bytes have been received with the proper byte spacing, alternates that selection of output between the odd phase and the even phase de-interleaver to maintain synchronization (block 1514).

As shown in FIG. 16, an example processor system 1600 that may be implemented within a mobile unit, such as the mobile unit 104 of FIG. 1, includes a processor 1602 having associated memories 1604, such as RAM 1606, ROM 1608, and flash memory 1610. The processor 1602 is coupled to an interface, such as a bus 1612 to which other components may be interfaced.

The processor 1602 may be any type of processing unit, such as a microprocessor and/or a DSP. The processor 1602 may include on-board A/D and D/A converters.

The memories 1604 that are coupled to the processor 1602 may be any suitable memory devices and may be sized to fit the storage and operational demands of the system 1600. The memories 1604 may also store instructions to implement the receive lineup of FIGS. 8, 12, and 14 and the processes of FIGS. 11, 13, and 15.

An input port 1614 may be coupled to an antenna or other hardware from which input signals, such as broadcast signals, are provided.

The display device 1616 may be, for example, a liquid crystal display (LCD) display or any other suitable device that acts as an interface between the processor 1602 and a user. The display device 1616 includes any additional hardware required to interface a display screen to the processor 1602.

Although certain apparatus constructed in accordance with the teachings of the invention have been described herein, the scope of coverage of this patent is not limited thereto. On the contrary, this patent covers every apparatus, method and article of manufacture fairly falling within the scope of the appended claims either literally or under the doctrine of equivalents.

What is claimed is:

1. A method of synchronizing a de-interleaver in a communication receiver receiving a signal including known information, the method comprising:
fixing a phase of a de-interleaver in a first state;
de-interleaving symbols in the signal while the phase of the de-interleaver is in the first state;
processing the de-interleaved symbols;
detecting if the known information is present in the processed de-interleaved symbols; and
switching the phase of the de-interleaver between the first state and a second state when the known information is detected in the processed de-interleaved symbols.

2. A method as defined in claim 1, wherein the fixing the phase of the de-interleaver in the first state comprises fixing the phase of the de-interleaver in an odd or an even phase.

3. A method as defined in claim 1, wherein switching the phase of the de-interleaver between the first state and the second state comprises alternating the phase of the de-interleaver between an odd phase and an even phase.

4. A method as defined in claim 1, wherein detecting if the known information is present in the processed de-interleaved symbols comprises detecting a plurality of sequences of the known information spaced at pre-determined intervals.

5. A method as defined in claim 1, wherein the signal comprises a digital video broadcast signal.

6. A method as defined in claim 5, wherein the digital video broadcast signal comprises an MPEG encoded stream.

7. A method as defined in claim 6, wherein the known information comprises an MPEG synchronization byte.

8. A method as defined in claim 1, further comprising leaving the phase of the de-interleaver in the first state until the known information is detected.

9. An article of manufacture comprising a machine-accessible medium having a plurality of machine accessible instructions that, when executed, cause a machine to synchronize a de-interleaver in a communication receiver receiving a signal including known information by:
fixing a phase of a de-interleaver in a first state;
de-interleaving symbols in the signal while the phase of the de-interleaver is in the first state;
processing the de-interleaved symbols;
detecting if the known information is present in the processed de-interleaved symbols; and
switching the phase of the de-interleaver between the first state and a second state when the known information is detected in the processed de-interleaved symbols.

10. A machine-accessible medium as defined by claim 10, wherein the fixing the phase of the de-interleaver in the first state comprises fixing the phase of the de-interleaver in an odd or an even phase.

11. A machine-accessible medium as defined by claim 10, wherein switching the phase of the de-interleaver between the first state and the second state comprises alternating the phase of the de-interleaver between an odd phase and an even phase.

12. A machine-accessible medium as defined by claim 10, wherein detecting if the known information is present in the processed de-interleaved symbols comprises detecting a plurality of sequences of the known information.

13. A machine-accessible medium as defined by claim 10, wherein the signal comprises a digital video broadcast signal.

14. A machine-accessible medium as defined by claim 14, wherein the digital video broadcast signal comprises an MPEG encoded stream.

15. A machine-accessible medium as defined by claim 15, wherein the known information comprises an MPEG synchronization byte.

16. A machine-accessible medium as defined by claim 10, wherein the plurality of machine accessible instructions, when executed, causes a machine to leave the phase of the de-interleaver in the first state until the known information is detected.

17. A system to synchronize a communication receiver receiving a signal including known information, the system comprising:
a de-interleaver responsive to a control signal, wherein the de-interleaver has a phase fixed in a first state based on the control signal, the de-interleaver de-interleaving symbols in the signal while the phase of the de-interleaver is in the first state;
a processor to operate on the de-interleaved symbols; and
a synchronization detector to detecting if the known information is present in the processed de-interleaved symbols and to output the control signal to the de-interleaver to cause the de-interleaver to switch the phase of the de-interleaver between the first state and a second state when the known information is detected in the processed de-interleaved symbols.

18. A system as defined in claim 17, wherein the fixing the phase of the de-interleaver in the first state comprises fixing the phase of the de-interleaver in an odd or an even phase.

19. A system as defined in claim 17, wherein switching the phase of the de-interleaver between the first state and the second state comprises alternating the phase of the de-interleaver between an odd phase and an even phase.

20. A system as defined in claim 17, wherein the synchronization detector comprises a comparator to compare the processed de-interleaved symbols to known information.

21. A method of synchronizing a de-interleaver in a communication receiver receiving a signal including known information, the method comprising:
fixing a phase of a first de-interleaver in a first state;
fixing a phase of a second de-interleaver in a second state;
de-interleaving symbols in the signal with the first de-interleaver and the second de-interleaver to produce first and second information streams;
detecting if the known information is present in the first information stream or the second information stream; and
selecting for output the information stream in which the known information stream was detected.

22. A method as defined in claim 21, wherein the first state is an odd state and the second state is an even state.

23. A method as defined in claim 21, further comprising alternating the selection of output of the first and second information streams to maintain synchronization.

24. A method as defined in claim 21, wherein detecting if the known information is present in the first information stream or the second information stream comprises detecting a plurality of sequences of the known information spaced at pre-determined intervals.

25. A system to synchronize a communication receiver receiving a signal including known information, the system comprising:
an odd phase de-interleaver receiving and de-interleaving a symbol stream;
an even phase de-interleaver receiving and de-interleaving the symbol stream;
a first decoder coupled to the odd phase de-interleaver and processing the de-interleaved symbol stream from the odd phase de-interleaver to produce a first information stream;
a second decoder coupled to the even phase de-interleaver and processing the de-interleaved symbol stream from the even phase de-interleaver to produce a second information stream;
a synchronization detector determining which of the first and second information streams includes the known information; and
an arbiter responsive to the synchronization detector for selecting for output the information stream including the known information.

26. A system as defined in claim 25, wherein the arbiter alternates selection of the information stream to maintain synchronization.

27. A system as defined in claim 25, wherein the synchronization detector determines which of the first and second information streams includes the known information by searching for the known information spaced at intervals within the first and second information streams.

28. An article of manufacture comprising a machine-accessible medium having a plurality of machine accessible instructions that, when executed, cause a machine to synchronize a de-interleaver in a communication receiver receiving a signal including known information by:
fixing a phase of a first de-interleaver in a first state;
fixing a phase of a second de-interleaver in a second state;
de-interleaving symbols in the signal with the first de-interleaver and the second de-interleaver to produce first and second information streams;
detecting if the known information is present in the first information stream or the second information stream; and
selecting for output the information stream in which the known information stream was detected.

29. A machine-accessible medium as defined by claim 28, wherein the plurality of machine accessible instructions, when executed, cause alternating selection of the information stream to maintain synchronization.
